(19) United States
(12) Patent Application Publication
(10) Pub. No.: US 2009/0272589 A1
(43) Pub. Date: Nov. 5, 2009

(54) ENGINE AIR FILTER SYSTEM

(76) Inventor: Claudio R. Ballard, Huntington, NY (US)

Correspondence Address: HOWISON & ARNOTT, L.L.P, P.O. BOX 741715, DALLAS, TX, 75374-1715, US

(21) Appl. No.: 12/395,684

(22) Filed: Mar. 1, 2009

Related U.S. Application Data
(60) Provisional application No. 61/034,474, filed on Mar. 6, 2008.

(51) Int. Cl. B60K 13/02

(52) U.S. Cl. 180/68.3

(57) ABSTRACT

An engine air filter system includes a vehicle nose having upper and lower walls defining an air passageway therethrough, with an air intake in fluid communication with the air passageway, a plenum mounted on the lower wall of the vehicle nose in fluid communication with the air passageway and having a lower end adapted for sealing engagement with an air entrance of a throttle body or intake manifold of the engine, wherein, when the nose is in a lowered position, air entering the air intake passes through the air passageway and the plenum and into the air entrance of a throttle body or intake manifold of the engine, and wherein the plenum is lifted away from the throttle body or intake manifold of the engine when the nose is moved to an open position, exposing the air entrance.

### CROSS-REFERENCE TO RELATED APPLICATIONS

This application claims the benefit of U.S. Provisional Application for Patent Ser. No. 61/034,474, filed Mar. 6, 2008, and entitled ENGINE AIR FILTER SYSTEM, the specification of which is incorporated herein in its entirety by reference.

### TECHNICAL FIELD

The following disclosure relates to an engine air filter system, and in particular to an air filter system that is selectively movable to reveal the engine's appearance.

### BACKGROUND

Conventional air filters for automobiles and trucks are mounted in a housing on top of the vehicle's engine, typically on top of an intake manifold. To access or view the intake manifold and other engine components, the filter housing must be unbolted from the manifold and removed. This can be a time consuming process requiring a number of tools to complete. Thus, there exists a need for a vehicle air filter system that does not require such disassembly and provides for convenient, ready access to the vehicle's engine components.

### SUMMARY

In one aspect thereof, an engine air filter system is disclosed. The engine air filter system consists of a vehicle nose having upper and lower walls defining an air passageway therethrough. The vehicle nose is configured to pivot around an end thereof to expose the engine compartment of the vehicle. The vehicle nose includes an air intake in fluid communication with the air passageway. An air intake formed in the vehicle nose conducts air through the passageway to at least one plenum mounted on the lower wall of the vehicle nose. The plenum is in fluid communication with the air passageway at an upper end thereof and includes a sealing feature at a lower end thereof. The sealing feature is adapted for sealing engagement with an air entrance of a throttle body or intake manifold of the engine. When the nose is in the lowered position, air entering the air intake passes through the air passageway and the plenum and into the air entrance of the throttle body or intake manifold of the engine. The plenum is lifted away from the intake manifold of the engine when the nose is moved to an open position, exposing the air entrance.

### BRIEF DESCRIPTION OF THE DRAWINGS

For a more complete understanding, reference is now made to the following description taken in conjunction with the accompanying Drawings in which:

FIGS. 1, 2 and 3 illustrate side, front and rear views of an automobile employing the engine air cleaning system of the present disclosure;

FIG. 4 illustrates a perspective view of the nose of the automobile of FIG. 1;

FIG. 5 illustrates a longitudinal section of the nose of FIG. 4;

FIG. 6 illustrates a bottom view of the nose of FIG. 4;

FIG. 7 illustrates an inverted bottom perspective view of the nose of FIG. 4;

FIG. 8 illustrates a perspective view further illustrating the configuration of the runners and seal plate of an intake manifold suitable for use with the nose of FIG. 4; and

FIG. 9 illustrates a partial cut away view of nose of FIG. 4.

### DETAILED DESCRIPTION

Referring now to the drawings, wherein like reference numbers are used herein to designate like elements throughout, the various views and embodiments of an engine air filter system. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

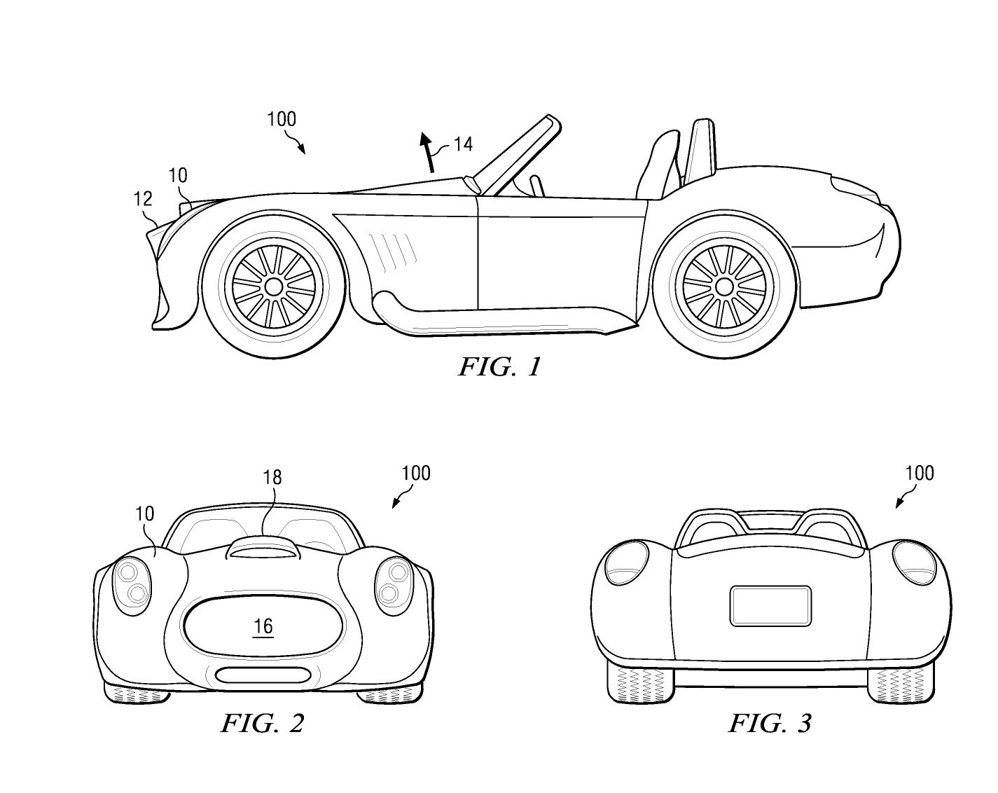

FIGS. 1, 2 and 3 are side, front and rear views of a two seat roadster style automobile 100 employing the engine air cleaning system disclosed herein. Automobile 100 includes a nose or hood 10 configured to pivot around a forward end 12 thereof when opened in the direction indicated by arrow 14. Nose 10 includes a front central opening 16 for receiving air therethrough.

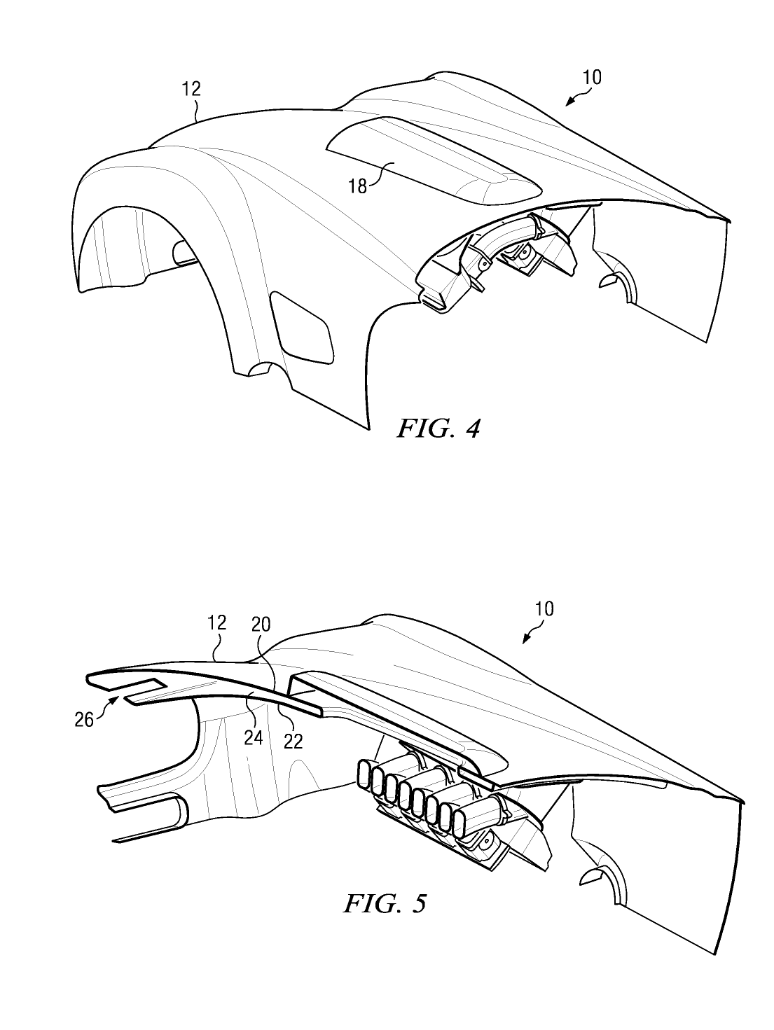

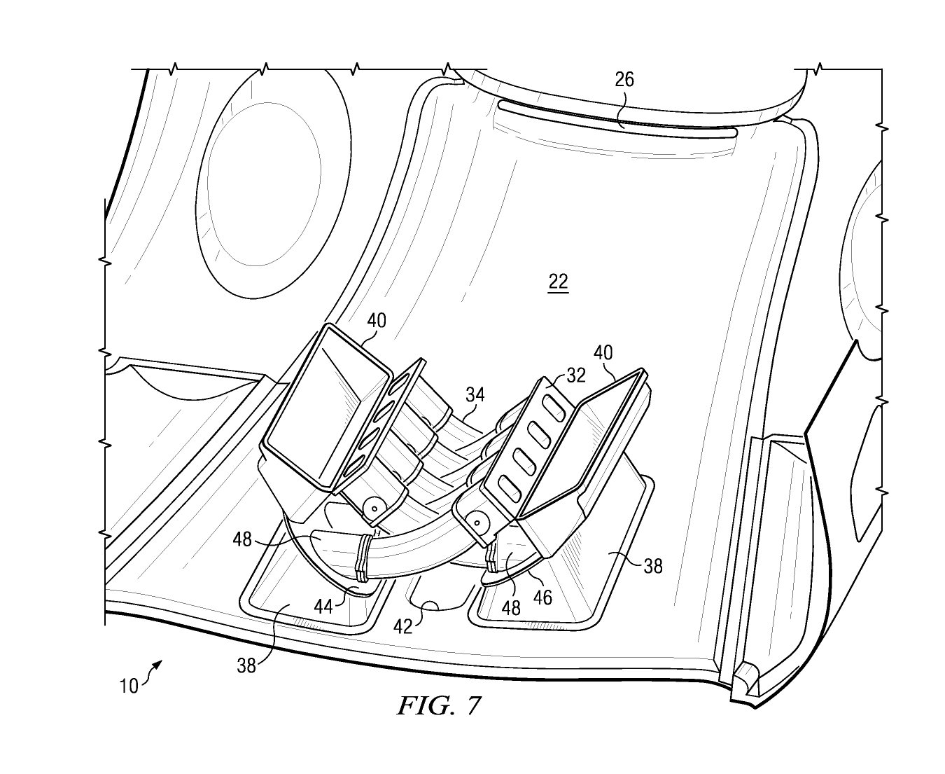

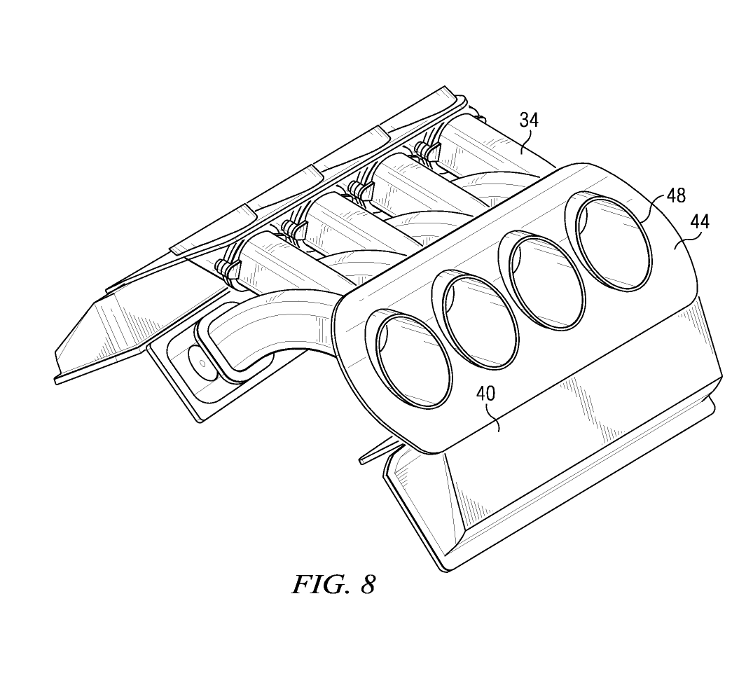

FIG. 4 is a perspective view of nose 10. In one embodiment, nose 10 includes a scoop shaped structure 18 formed in an upper surface of the nose. An opening 42 (FIG. 7) beneath scoop 18 opens into the engine compartment of the vehicle.

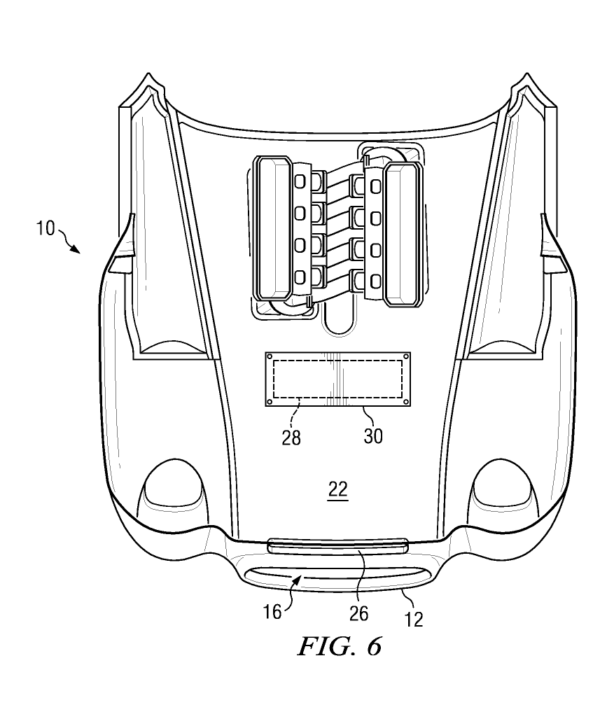

FIG. 5 is a longitudinal section of nose 10. In one embodiment, nose 10 includes an upper wall 20, a lower wall 22 and an air passageway 24 between the upper and lower walls. One or more air intake openings 26 are formed in lower wall 22 such that air can flow through the lower wall and into passageway 24. In some variations, an open slot (not shown) between upper wall 20 and lower wall 22 is provided at the front end of the nose near the opening 16 to allow outside air to enter passageway 24.

FIG. 6 is a bottom view of nose 10. In one variation, one or more filter elements 28 are disposed in air passageway 24 to filter air flowing to the engine of automobile 100. Filter elements 28 may be conventional paper or foam type air filters. A removable panel 30 provides access to air filter 28 for servicing or replacing of the filter.

FIG. 7 is an inverted bottom perspective view of nose 10 (i.e., for purposes of illustration, the lower surface of the nose is shown facing up and the upper surface of the nose is shown facing down in FIG. 7) further illustrating the throttle bodies 32 and air intake runners 34 of an engine. In some variations, the throttle bodies may be replaced by one or more intake manifolds. As illustrated, a pair of plenums 38 are mounted on lower wall 22 of nose 10. Plenums 38 open into air passageway 24 at the upper ends thereof. When the nose 10 is in the normal, i.e., lowered, position (see FIGS. 1-3), air passing through plenums 38 flows through runners 34 to throttle bodies 32. In the illustrated embodiment two plenums 38 are provided to conduct air to the throttle bodies 32 of a V-configured engine such as a V6 or V8. In other embodiments, a single plenum 38 may be utilized to conduct air to the throttle bodies or intake manifold of an inline engine.

FIG. 7 also illustrates valve covers 40 (the cylinder heads are not shown for purpose of illustration) and an opening 42 through nose 10 that opens into scoop 18 (see FIG. 2). Each of the runners 34 extends from a throttle body 32 to a flared air entrance fitting 48 or “trumpet.” A seal plate 44 is disposed around each bank of trumpets 48 with an airtight seal. In one variation, the airtight seal between seal plate 44 and trumpets 48 is formed by elastic seals or gaskets (not shown). In another variation, the seal plate 44 and the trumpets 48 are fabricated as portions of a single assembly, e.g., by welding individual parts together or machining from a single billet, and thus have an inherent airtight seal. The lower end of the plenums 38 are configured to seal tightly against the seal plate 44 when the nose is in the lowered position. Thus, when the nose is in the lowered position, the air entrance trumpets 48 are supplied only with clean, filtered air that has traveled through the passageway 24, filters 28 and plenums 38. When the nose 10 is in the raised position, the plenums 38 are lifted away from the seal plates 44, thus revealing the appearance of the engine's air entrances without obstructions (see FIG. 8).

In one embodiment, the plenums 38 have a corresponding sealing feature 46 such as a flange extending around the perimeter of the lower end of the plenum. A gasket (not shown) formed from an appropriate material such as an elastomer or plastic may be provided to enhance the seal between seal plate 44 and seal feature 46.

FIG. 8 is a top perspective view further illustrating the configuration of runners 34, trumpets 48 and seal plate 44. As illustrated, each of runners 34 passes through seal plate 44, terminating in a trumpet 48. In one variation, trumpets 48 are flared to a larger diameter or cross section than runners 34.

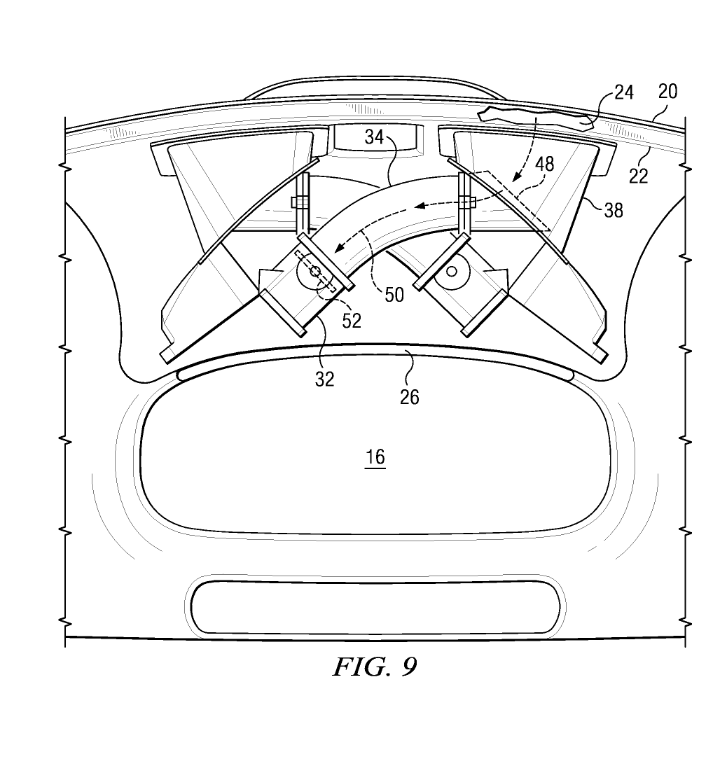

FIG. 9 is a partial cut away view of nose 10. Dashed line 50 illustrates the path of air flowing from air passageway 24 through plenums 38 and trumpet 48. From trumpet 48 the air passes through runners 34 and into throttle bodies 32. FIG. 9 also illustrates the throttle body butterfly valve (shown in phantom), which regulates the flow of air to each cylinder of the engine.

While the illustrated embodiment includes a vehicle having a rotating nose or hood, it will be appreciated that the previously described engine air filter system is equally applicable to use on vehicles having a conventional fixed nose with opening hood, wherein the components previously described as being on the underside of the nose will instead be formed on the underside of the hood. When the hood is in the lowered position, the plenums will seal against the seal plate surrounding the air entrances of the engine, and the engine will receive filtered air, whereas when the hood is lifted, the plenums will separate from the seal plate, and the engine's air entrances will be visible without obstructions.

It will be appreciated by those skilled in the art having the benefit of this disclosure provides an engine air filter system. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

1. An engine air filter system comprising:
a vehicle nose having upper and lower walls defining an air passageway therethrough, wherein the vehicle nose is configured to pivot around a front end thereof to expose the engine compartment of the vehicle, the vehicle nose further comprising an air intake in fluid communication with the air passageway;
at least one plenum mounted on the lower wall of the vehicle nose, the plenum in fluid communication with the air passageway at an upper end thereof with a sealing feature at a lower end thereof, the sealing feature adapted for sealing engagement with an air entrance of a throttle body or intake manifold of the engine; and
wherein, when the nose is in a lowered position, air entering the air intake passes through the air passageway and the plenum and into the air entrance of the throttle body or intake manifold of the engine, and wherein the plenum is lifted away from the throttle body or intake manifold of the engine when the nose is moved to an open position, exposing the air entrance.

2. The engine air filter system of claim 1, further comprising an air filter element disposed in the air passageway.

3. The engine air filter system of claim 2, further comprising a removable panel for accessing the air filter element disposed in the air passageway.

4. The engine air filter system of claim 1, further comprising a pair of plenums mounted on the lower wall of the vehicle nose, each of the plenums in fluid communication with the air passageway at an upper end thereof with a sealing feature at a lower end thereof, the sealing feature adapted for sealing engagement with an air entrance of a throttle body or intake manifold of a V-configured engine.

5. The engine air filter system of claim 4 wherein the plenums open into air intake runners, the intake runners connecting the plenums to throttle bodies for each of the engine's cylinders.

6. The engine air filter system of claim 5 further comprising a flared air entrance fitting for connecting each of the intake runners to a throttle body.

7. A vehicle engine air filter system comprising:
a vehicle hood covering the engine compartment of the vehicle, the hood configured to pivot to open to the vehicle engine compartment, the vehicle hood further comprising an air passageway between upper and lower walls thereof and an air intake for directing air into the air passageway;
a plenum mounted on the lower wall of the vehicle hood, the plenum in fluid communication with the air passageway at an upper end thereof and extending downward to the vehicle engine, the plenum connecting the air passageway with a plurality of throttle bodies of the vehicle engine; and
wherein, when the hood is in a lowered position, air entering the air intake passes through the air passageway and the plenum and into the air entrance of a plurality of throttle bodies, and wherein when the hood is opened, the plenum is lifted away from the throttle bodies, exposing the air entrance.

8. The vehicle engine air filter system of claim 7, further comprising a filter element disposed in the air passageway.

9. The vehicle engine air filter system of claim 8, further comprising a removable panel in the lower wall of the hood for accessing the air filter element disposed in the air passageway.

10. The vehicle engine air filter system of claim 7, further comprising a pair of plenums mounted on the lower wall of the vehicle hood, each of the plenums in fluid communication with the air passageway at an upper end thereof with a sealing feature at a lower end thereof, the sealing feature adapted for sealing engagement with an air entrance of a plurality of throttle bodies of a V-configured engine.

11. The vehicle engine air filter system of claim 10 wherein the plenums open into air intake runners, the intake runners connecting the plenums to throttle bodies for each of the engine's cylinders.

12. The vehicle air filter system of claim 7 including a sealing feature at a lower end of the plenum, the sealing feature adapted for sealing engagement with an air entrance of a plurality of throttle bodies of the engine.

13. The engine air filter system of claim 12 further comprising a flared air entrance fitting for connecting each of the intake runners to a throttle body.

14. A vehicle engine air intake system comprising:
a plurality of throttle bodies;
a plurality of intake runners, each intake runner providing air to one of the throttle bodies;
a vehicle hood having an air passageway therethrough, wherein the vehicle hood is configured to pivot around a front end thereof to expose the engine compartment of the vehicle, the vehicle hood further comprising an air intake in fluid communication with the air passageway;
at least one plenum mounted on and extending downward from vehicle hood into an engine compartment of the vehicle, the plenum in fluid communication with the air passageway at an upper end thereof and directing air into the intake runners; and
wherein, when the hood is in a lowered position, air entering the air intake passes through the air intake and air passageway and the plenum and into an air entrance of the throttle bodies, and wherein the plenum is lifted away from the throttle bodies when the hood is moved to an open position, exposing the throttle bodies.

15. The vehicle engine air intake system of claim 14, wherein the plenum includes a sealing feature at a lower end thereof, the sealing feature adapted for sealing engagement with an air entrance of a throttle body.

16. The vehicle engine air intake system of claim 14, further comprising a pair of plenums mounted on a lower wall of the vehicle hood, each of the plenums in fluid communication with the air passageway at an upper end thereof with a sealing feature at a lower end thereof, the sealing feature adapted for sealing engagement with an air entrance of a plurality of throttle bodies of a V-configured engine.

17. The vehicle engine air intake system of claim 16 wherein the plenums open into air intake runners, the intake runners connecting the plenums to throttle bodies for each of the engine's cylinders.

18. The vehicle engine air intake system of claim 14, further comprising a filter element disposed in the air passageway; and a removable panel in the lower wall of the hood for accessing the air filter element disposed in the air passageway.

19. The vehicle engine air intake system of claim 14 further comprising a scoop shaped structure formed in an upper surface of the hood.

20. The vehicle engine air intake system of claim 19 wherein an opening beneath the scoop opens into the engine compartment of the vehicle.
